(19) United States
(12) Patent Application Publication
(10) Pub. No.: US 2026/0140845 A1
(43) Pub. Date: May 21, 2026

(54) PREDICTIVE, CONTEXT-RESPONSIVE LOGGING OF THE OPERATION OF A PROCESS

(71) Applicant: Dell Products L.P., Round Rock, TX (US)

(72) Inventor: Pankaj Pande, CARLINGFORD (AU)

(21) Appl. No.: 18/949,464

(22) Filed: Nov. 15, 2024

(51) Int. Cl. G06F 11/34; G06F 11/07

(52) U.S. Cl. CPC G06F 11/3476; G06F 11/0754

(57) ABSTRACT

The technologies described herein are generally directed toward predictive, context-responsive logging of the operation of a process. According to an embodiment, a system can comprise a processor and a memory that can enable performance of operations including monitoring, by a device including at least one processor, a process operated by a system, and the monitoring may be based on a logging parameter. The operations further include, based on the logging parameter and at least one result of the monitoring, generating, by the device, a log of the process. Further, the operations include, based on a condition determined to be associated with operation of the process, adjusting, by the device, the logging parameter.

### BACKGROUND

Modern systems that monitor the operations of automated processes may be configured to log a variety of different operating characteristics. Many different parameters may be specified, and different goals of monitoring different processes at different times may require significantly different combinations of settings to be achieved.

In some circumstances, the operational contexts of a logged process may change rapidly and in unexpected ways. In addition, the goals of monitoring a process may be changed during operation of the process. Because logging systems are often configured before operation of the process, changes in the operating context of the process may require stopping or modifying the operation of the process to effect changes to the logging configuration. It may be difficult for logging systems to capture the data required to satisfy different goals when operational contexts for complex processes are rapidly changing.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example method may include monitoring, by a device including at least one processor, a process operated by a system, and the monitoring may be based on a logging parameter. The method may further include, based on the logging parameter and at least one result of the monitoring, generating, by the device, a log of the process. The method may further include, based on a condition determined to be associated with operation of the process, adjusting, by the device, the logging parameter.

Additionally or alternatively, the logging parameter may include a verbosity parameter representative of a verbosity of the log of the process. Additionally or alternatively, the logging parameter may include a sampling rate parameter representative of a sampling rate applicable to the monitoring of the process. Additionally or alternatively, the logging parameter may include a level of detail parameter representative of a level of logging detail of the log of the process. Additionally or alternatively, the log may include a first log, and the logging parameter may include a parameter indicative of whether to add metadata to the first log to facilitate joining the first log to a second log of the process different from the first log.

Additionally or alternatively, the method may further include, identifying, by the device, a pattern associated with the operation of the process, and the condition may include a predicted change in the pattern associated with the operation of the process. Additionally or alternatively, the pattern may include a historical pattern associated with the operation of the process, and the predicted change may include a predicted deviation in the operation of the process from the historical pattern. Additionally or alternatively, the identifying may be based on a time series analysis of the operation of the process.

Additionally or alternatively, the condition may include a prediction that an error is threshold likely to occur. Additionally or alternatively, the adjusting of the logging parameter may be based on a model that was generated based on previous operations of the process. Additionally or alternatively, the model may have been generated further based on an analysis of feature importance by a random forest classifier. Additionally or alternatively, the method may further include, updating, by the device, the model, based on the condition, the adjusting of the logging parameter, and a result of the adjusting of the logging parameter. Additionally or alternatively, the condition may include a predicted change in an operating state of the system. Additionally or alternatively, the condition may include a predicted change in an operating state of the device.

An example system can operate as follows. A memory may store computer executable components, and a processor, operably coupled to the memory, may execute the computer executable components stored in the memory. The computer executable components may include a receiver that receives log data from monitoring equipment that monitors operation of a system based on a logging configuration. The computer executable components may further include a predictor that predicts a condition associated with the operation of the system. The computer executable components may further include an adjustor that adjusts the logging configuration based on the condition.

Additionally or alternatively, the condition may include an operational context of the system. Additionally or alternatively, the operational context may include a demand load of the system satisfying a function with respect to a threshold amount of load.

An example non-transitory machine-readable medium may include executable instructions that, when executed by at least one processor, facilitate performance of operations. The operations may include logging events of a process performed by a device, and the logging may be based on a parameter. The operations may further include, based on a model trained based on training data obtained from operation of the process, identifying a condition associated with operation of the process, resulting in an identified condition. The operations may further include, based on the identified condition, changing the parameter to a changed parameter applicable to further logging of the events of the process.

Additionally or alternatively, the model may include a time series model that was generated based on the training data obtained from the operation of the process.

Additionally or alternatively, the identified condition may include satisfaction of a predicted level of efficiency of the logging of the events.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 is an architecture diagram of an example system that can facilitate predictive, context-responsive logging of the operation of a process, in accordance with one or more embodiments.

FIG. 2 is an architecture diagram of an example system that can facilitate predictive, context-responsive logging of the operation of a process, in accordance with one or more embodiments.

FIG. 3 illustrates a flow diagram of an example portion of processes that can facilitate predictive, context-responsive logging of the operation of a process, in accordance with one or more embodiments.

FIG. 4 illustrates a flow diagram that continues the example portion of processes from FIG. 3, that can facilitate predictive, context-responsive logging of the operation of a process, in accordance with one or more embodiments.

FIG. 5 is an architecture diagram of a context detection engine that can facilitate predictive, context-responsive logging of the operation of a process, in accordance with one or more embodiments.

FIG. 6 is an architecture diagram of a historical analysis module 600 that can facilitate predictive, context-responsive logging of the operation of a process, in accordance with one or more embodiments.

FIG. 7 depicts example code for a system that can be used to facilitate predictive, context-responsive logging of the operation of a process, in accordance with one or more embodiments.

FIG. 8 depicts example code for a system that can be used to facilitate predictive, context-responsive logging of the operation of a process, in accordance with one or more embodiments.

FIG. 9 depicts example code for a system that can be used to facilitate predictive, context-responsive logging of the operation of a process, in accordance with one or more embodiments.

FIG. 10 depicts example code for a system that can be used to facilitate predictive, context-responsive logging of the operation of a process, in accordance with one or more embodiments.

FIG. 11 depicts example code for a system that can be used to facilitate predictive, context-responsive logging of the operation of a process, in accordance with one or more embodiments.

FIG. 12 depicts example code for a system that can be used to facilitate predictive, context-responsive logging of the operation of a process, in accordance with one or more embodiments.

FIG. 13 depicts example code for a system that can be used to facilitate predictive, context-responsive logging of the operation of a process, in accordance with one or more embodiments.

FIG. 14 depicts example code for a system that can be used to facilitate predictive, context-responsive logging of the operation of a process, in accordance with one or more embodiments.

FIG. 15 depicts example code for a system that can be used to facilitate predictive, context-responsive logging of the operation of a process, in accordance with one or more embodiments.

FIG. 16 illustrates a flow diagram of an example method that can be used to facilitate predictive, context-responsive logging of the operation of a process, in accordance with one or more embodiments.

FIG. 17 depicts an example system that can facilitate predictive, context-responsive logging of the operation of a process, in accordance with one or more embodiments.

FIG. 18 depicts an example non-transitory machine-readable medium that can include executable instructions that, when executed by a processor of a system, facilitate predictive, context-responsive logging of the operation of a process, in accordance with one or more embodiments.

FIG. 19 depicts an example schematic block diagram of a computing environment with which the disclosed subject matter can interact.

FIG. 20 illustrates an example block diagram of a computer operable to execute an embodiment of this disclosure.

### DETAILED DESCRIPTION

Generally speaking, one or more embodiments described herein can facilitate predictive, context-responsive logging of the operation of a process, in accordance with one or more embodiments.

As is understood by one having skill in the relevant art(s), given the description herein, the implementation(s) described herein are non-limiting examples, and variations to the technology can be implemented. For instance, even though many examples described herein discuss logging by a service provider of logging equipment and a process operating on process equipment, the technologies described herein can be used in many similar circumstances, e.g., for providing adaptive logging approaches for logging processes that are a part of a process. As such, any of the embodiments, aspects, concepts, structures, functionalities, implementations and/or examples described herein are non-limiting, and the technologies described and suggested herein can be used in various ways that provide benefits and advantages to logging system technology in general, both for existing technologies and technologies in this and similar areas that are yet to be developed.

Aspects of the subject disclosure will now be described more fully hereinafter with reference to the accompanying drawings in which example components, graphs and operations are shown. In the following description, for purposes of explanation, numerous specific details are set forth in order to provide a thorough understanding of the various embodiments. However, the subject disclosure may be embodied in many different forms and should not be construed as limited to the examples set forth herein.

Generally speaking, one or more embodiments described herein integrate real-time context awareness, historical analysis, and dynamic adjustment capabilities, to provide an adaptive and predictive logging solution. As described, the closed-loop nature of one or more embodiments, where each component continuously learns and adapts based on the inputs from other components, facilitates the configuration of a logging system to evolve alongside the application that is being monitored.

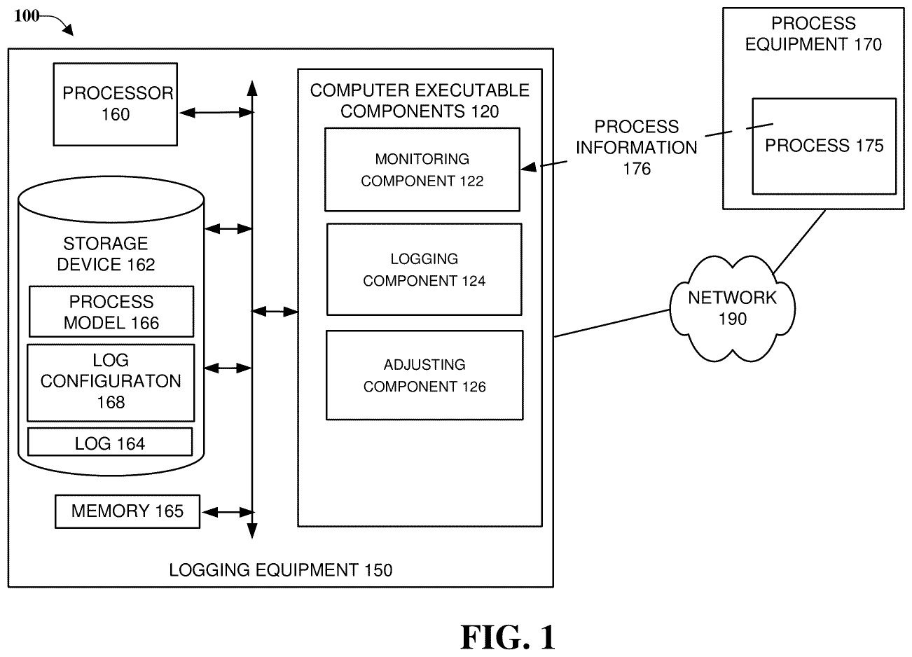

FIG. 1 is an architecture diagram of an example system 100 that can facilitate predictive, context-responsive logging of the operation of a process, in accordance with one or more embodiments. For purposes of brevity, description of like elements and/or processes employed in other embodiments is omitted. As depicted, system 100 includes logging equipment 150 connected to process equipment 170 via network 190. Process equipment 170 is depicted as operating process 175.

As depicted, logging equipment 150 can include memory 165 that can store one or more computer and/or machine readable, writable, and/or executable components 120 and/or instructions. In embodiments, logging equipment 150 can further include processor 160. In one or more embodiments, computer-executable components 120, when executed by processor 160, can facilitate performance of operations defined by the executable component(s) and/or instruction(s). Computer executable components 120 can include monitoring component 122, logging component 124, adjusting component 126, and other components described or suggested by different embodiments described herein, that can improve the operation of system 100. Logging equipment 150 may further include storage device 162. In an example, storage device 162 may provide nonvolatile storage of data, data structures, computer-executable instructions, and so forth. Example data stored using storage device 162 include process model 166, log configuration 168, and log 164.

As depicted, system 100 shows a logical connection between logging equipment 150 and process equipment 170. A logical connection is depicted where process information 176 may be communicated by process equipment 170 to monitoring component 122 of logging equipment 150.

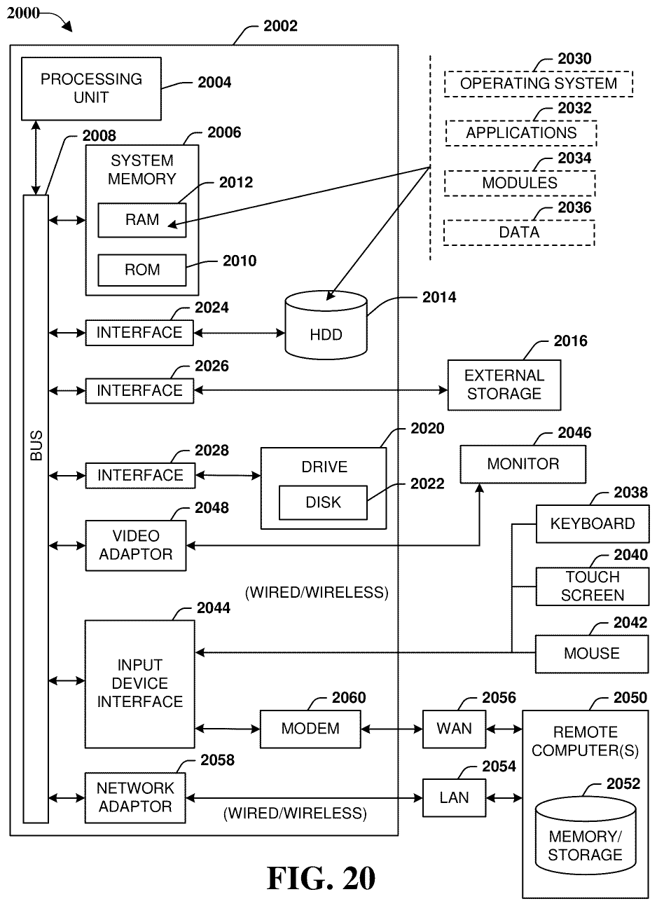

According to multiple embodiments, processor 160 can comprise one or more processors and/or electronic circuitry that can implement one or more computer and/or machine readable, writable, and/or executable components and/or instructions that can be stored on memory 165. For example, processor 160 can perform various operations that can be specified by such computer and/or machine readable, writable, and/or executable components and/or instructions including, but not limited to, logic, control, input/output (I/O), arithmetic, and/or the like. In some embodiments, processor 160 can comprise one or more components including, but not limited to, a central processing unit, a multi-core processor, a microprocessor, dual microprocessors, a microcontroller, a System on a Chip (SOC), an array processor, a vector processor, and other types of processors. Further examples of processor 160 are described below with reference to processing unit 2004 of FIG. 20. Such examples of processor 160 can be employed to implement any embodiments of the subject disclosure.

As discussed further with FIG. 20 below, network 190 can employ various wired and wireless networking technologies. For example, embodiments described herein can be exploited in substantially any wireless communication technology, comprising, but not limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2(3GPP 2 ) ultra-mobile broadband (UMB), fifth generation core (5G Core), fifth generation option 3x (5G Option 3x), high speed packet access (HSPA), Z-Wave, Zigbee and other 802.XX wireless technologies and/or legacy telecommunication technologies.

In some embodiments, memory 165 can comprise volatile memory (e.g., random access memory (RAM), static RAM (SRAM), dynamic RAM (DRAM), etc.) and/or non-volatile memory (e.g., read only memory (ROM), programmable ROM (PROM), electrically programmable ROM (EPROM), electrically erasable programmable ROM (EEPROM), etc.) that can employ one or more memory architectures. Further examples of memory 165 are described below with reference to system memory 2006 and FIG. 20. Such examples of memory 165 can be employed to implement any embodiments of the subject disclosure.

It is understood that the computer processing systems, computer-implemented methods, apparatus, and computer program products described herein employ computer hardware and/or software to solve problems that are highly technical in nature (e.g., analyzing the operation of operating process 175 in real-time and adjusting logging procedures based on context and predictive analysis), that are not abstract and cannot be performed as a set of mental acts by a human. For example, a human, or even a plurality of humans, cannot efficiently handle the root cause analysis for system faults that include the complex interactions described herein, with a level of accuracy and/or efficiency as the various embodiments described herein.

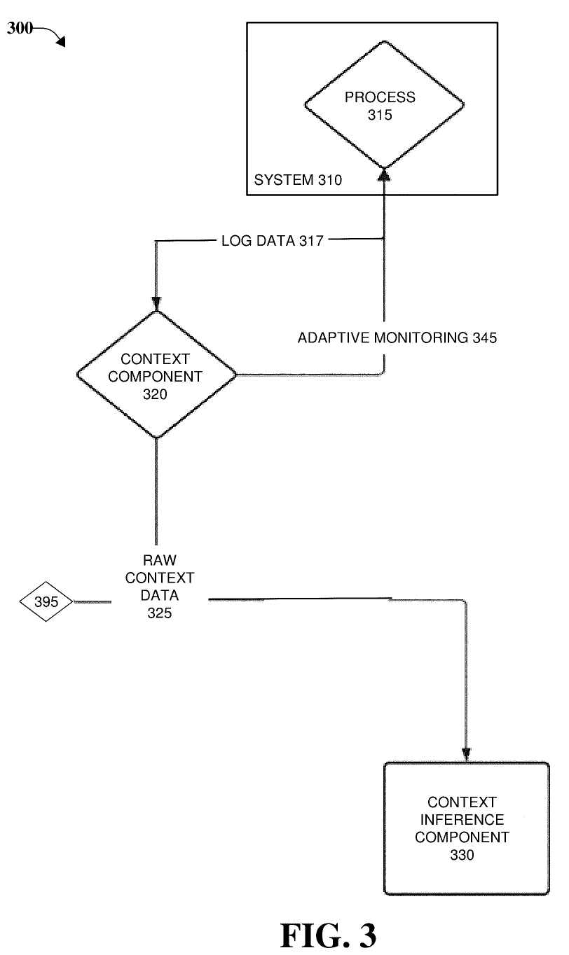

In one or more embodiments, computer executable components 120 can be used in connection with implementing one or more of the systems, devices, components, and/or computer-implemented operations shown and described in connection with FIG. 1 or other figures disclosed herein. In an example, memory 165 can store executable instructions that can facilitate generation of monitoring component 122, which can in some implementations monitor a process operated by a system, with the monitoring being based on a logging parameter. For example, in one or more embodiments, monitoring component 122 may monitor process 175, with the monitoring being based on a logging parameter included in log configuration 168. In an example, monitoring component 122 may monitor process 175 via process information 176 received from process equipment 170. Different approaches to collecting and processing information 176 are discussed in FIGS. 3-6 below.

In another example, memory 165 can store executable instructions that can facilitate generation of logging component 124, which can in some implementations, based on the logging parameter and at least one result of the monitoring, generate a log of the process. For example, in one or more embodiments, logging component 124 may, based on the logging parameter of log configuration 168, and at least one result of the monitoring of process 175, generate a log of the process. In an example, logging component 124 may generate log 164 based on log configuration 168 and process information 176.

In another example, memory 165 can store executable instructions that can facilitate generation of adjusting component 126, which can in some implementations can, based on a condition determined to be associated with operation of the process, adjust the logging parameter. For example, in one or more embodiments, adjusting component 126 may, based on a condition determined to be associated with operation of process 175, adjust the logging parameter of log configuration 168. As used herein, a logging parameter broadly describes a characteristic of the logging process, including, but not limited to, a number of log levels, content logged, and sampling rates.

As discussed further with the descriptions of FIGS. 3-6 below, in an implementation, adjusting component 126 may adjust logging parameters based on predictive analysis of the operation of process 175. For example, historical data that describes the past operation of process 175 in different contexts may be integrated in process model 166 and analyzed to predict future requirements and determine adjustments therefor.

It is appreciated that the embodiments of the subject disclosure depicted in various figures disclosed herein are for illustration only, and as such, the architecture of such embodiments are not limited to the systems, devices, and/or components depicted therein. For example, in some embodiments, logging equipment 150 and process equipment 170 can further comprise various computer and/or computing-based elements described herein with reference to operating environment 2000 and FIG. 20. In one or more embodiments, such computer and/or computing-based elements can be used in connection with implementing one or more of the systems, devices, components, and/or computer-implemented operations shown and described in connection with FIG. 1 or other figures disclosed herein.

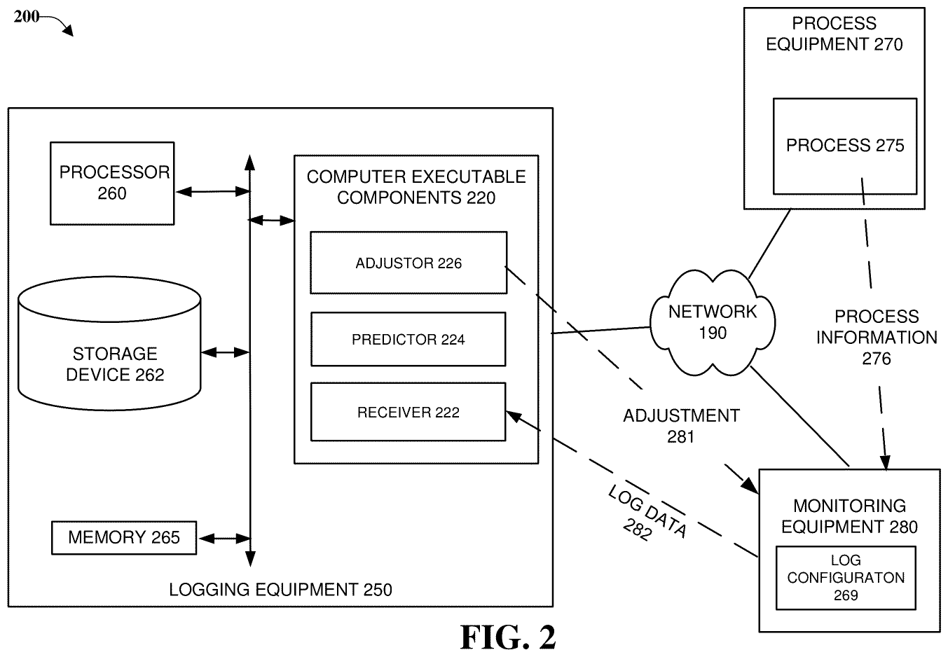

It should be noted that logging equipment 150, process equipment 170, and other devices discussed herein, can execute code instructions that may operate on servers or systems, remote data centers, or ‘on-box’ in individual client information handling systems, according to various embodiments herein. In some embodiments, it is understood any or all implementations of one or more embodiments described herein can operate on a plurality of computers, collectively referred to as logging equipment 150. For example, one or more of logging equipment 150 and process equipment 170 can all be separate subsystems running in the kernel of a computing device as well as operating on separate network equipment, e.g., as depicted in FIGS. 1 and 2.

FIG. 2 is an architecture diagram of an example system 200 that can facilitate predictive, context-responsive logging of the operation of a process, in accordance with one or more embodiments. For purposes of brevity, description of like elements and/or processes employed in other embodiments is omitted. As depicted, system 200 includes logging equipment 250, monitoring equipment 280, and process equipment 270. Logging equipment 250, includes processor 260, memory 265, storage device 262, and computer executable components 220. Process equipment 270 includes process 275 and monitoring equipment 280 includes log configuration 269, according to one or more embodiments.

In embodiments, processor 260 is similar to processor 160 and storage device 262 is similar to storage device 162, discussed above. According to multiple embodiments, memory 265 can store one or more computer and/or machine readable, writable, and/or executable components 220 and/or instructions. In one or more embodiments, computer-executable components 220, when executed by processor 260, can facilitate performance of operations defined by the executable component(s) and/or instruction(s). Computer executable components 220 can include receiver 222, predictor 224, adjustor 226, and other components described or suggested by different embodiments described herein, e.g., that can improve the operation of system 200, in accordance with one or more embodiments.

In an example implementation of logging equipment 250, memory 265 can store executable instructions that can facilitate generation of receiver 222, which in some implementations, can receive log data from monitoring equipment that monitors operation of a system based on a logging configuration. For example, in an embodiment, receiver 222 may receive log data 282 from monitoring equipment 280 that monitors operation of a system (e.g., process 275) based on log configuration 269, e.g., by receiving process information 276 describing process 275.

In an example implementation of logging equipment 250, memory 265 can further store executable instructions that can facilitate generation of predictor 224, which in some implementations, can predict a condition associated with the operation of the system. In an example, predictor 224 can predict a condition associated with the operation of the process 275 and process equipment 270. In one or more embodiments, predictor 224 can facilitate the prediction of different future contexts for the logged process 275. Different approaches to collecting and processing log data 282 are discussed in FIGS. 3-6 below.

In an example implementation of logging equipment 250, memory 265 can further store executable instructions that can facilitate generation of adjustor 226, which in some implementations, can adjust the logging configuration based on the condition. In an example, adjustor 226 can provide adjustment 281 to monitoring equipment, where the information may be used to adjust log configuration 269. In an implementation, adjustor 226 may adjust logging parameters based on a condition determined by the predictive analysis, by predictor 224, of the operation of process 275. For example, historical data that describes the past operation of process 275 in different contexts may be analyzed to predict future requirements and, in response to the future requirements, adjustor 226 can provide adjustment 281 to modify log configuration 269.

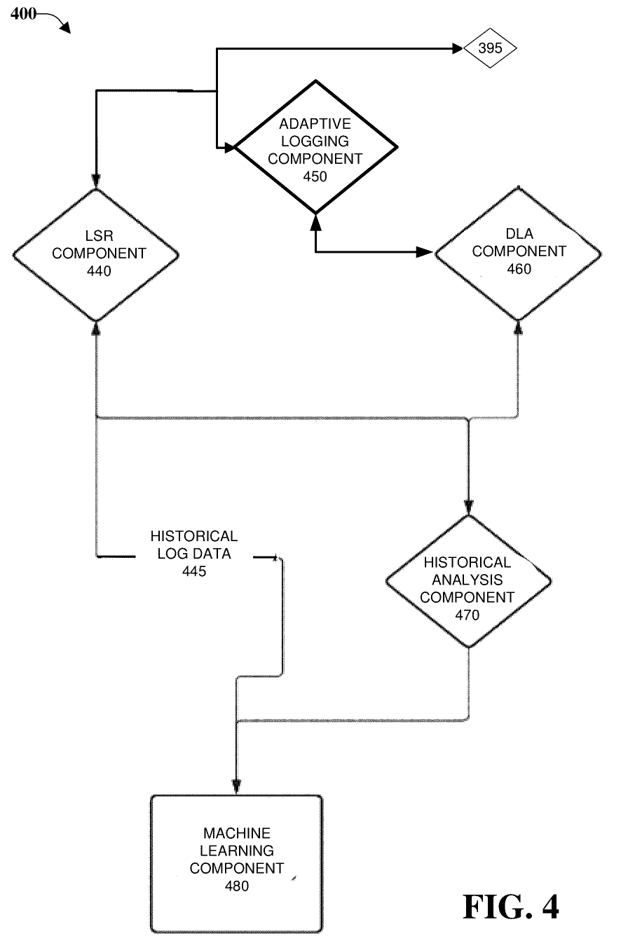

FIGS. 3-4 illustrate connected flow diagrams 300 and 400 of example portions of processes that can facilitate predictive, context-responsive logging of the operation of a process, in accordance with one or more embodiments. For purposes of brevity, description of like elements and/or processes employed in other embodiments is omitted.

As depicted, FIG. 3 includes system 310, context component 320, and context inference component 330. System 310 includes process 315, and provides log data 317 to context component 320. Context component 320 performs adaptive monitoring 345 of process 315, and provides raw context data to context inference component 330. FIG. 4 includes adaptive logging component 450, dynamic log adjustment (DLA) component 460, log storage and retrieval (LSR) component 440, historical analysis component 470, and machine learning component 480.

As depicted in flow diagram 300, context component 320 receives log data 317 from process 315 hosted by system 310. Log data 317 may be received based on an adaptive monitoring 345 process, where certain aspects of process 315 are monitored and provided as log data 317. Based on analysis of log data 317, context component may identify different operational contexts in which log data 317 is operating, resulting in raw context data 325.

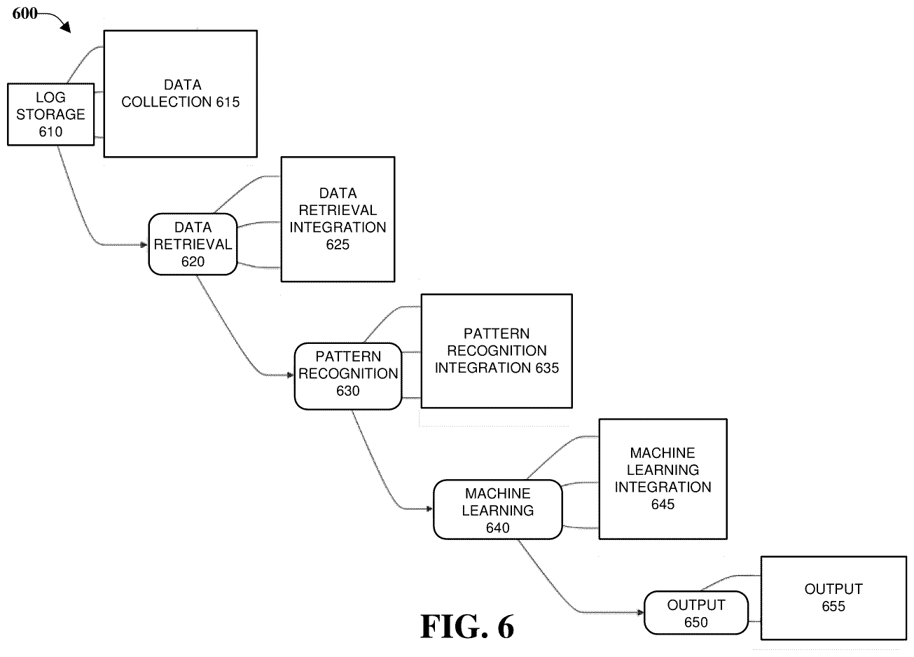

In one or more embodiments, context component 320 provides raw context data 325 to context inference component 330 for processes discussed below with FIG. 6 below, including long-term pattern recognition. Context component 320 may also send instructions to system 310 for adaptive monitoring 345 of process 315. Context component also provides 395 raw context data 325 to LSR component 440 and adaptive logging component 450, depicted in FIG. 4 and described below. The operation of context component 320 and context inference component are discussed with FIG. 6 below.

As depicted in flow diagram 400, LSR component 440 receives raw context data 325 from context component 320. In an embodiment, LSR component 440 may store, index, and retrieve log data, e.g., storing log data in log 164 described in FIG. 1. LSR component 440 may facilitate the persistent storage of log data, as well as providing an interface for log analysis and troubleshooting. As described further below, LSR component 440 may provide log data to other parts of the system, e.g., to inform predictive analysis of past log data to improve future logging configurations.

Adaptive logging component 450 receives raw context data 325 from context component 320. In one or more embodiments, adaptive logging component 450 may implement the log configuration changes (e.g., adjustment 281) determined by DLA component 460.

In different implementations, adaptive logging component 450 may perform different operations including dynamic log injection, log message enhancement, and performance improvement. In the dynamic log injection operation, adaptive logging component 450 may interface directly with the application code, injecting adaptive logging behaviors without requiring extensive modifications to the existing codebase. In an implementation, this interface with the application code may include runtime modification of log statements'behavior, based adjustments from DLA component 460.

The log message enhancement operation performed by adaptive logging component 450 may include an automatic enrichment of log entries with contextual information provided by context component 320.

Adaptive logging component 450 interacts closely with the application code of process 315, DLA component 460, and LSR component 440. Adaptive logging component 450 may receive instructions from DLA component 460, apply the instructions to the logging process, and send the generated logs to LSR component 440 for storage and analysis.

DLA component 460 may provide instructions to change how context component 320 performs adaptive monitoring 345 of process 315, e.g., adaptive decisions about logging levels, content, sampling rates and other logging parameters. DLA component 460 may perform real-time analysis of current context based on predefined and learned logging policies to achieve rapid matching of current context with similar historical contexts.

Logging parameters that may be modified include the dynamic adjustment of log levels (DEBUG, INFO, WARN, ERROR, CRITICAL) based on current context and historical patterns. Logging parameters that may be modified further include the enabling/disabling of specific log categories or components based on relevance to the current context, and dynamic adjustment of log detail level for different application components. Logging parameters that may be modified further include the sampling rate, e.g., adaptive sampling for high-volume events or problematic areas, to balance between comprehensive logging and system performance.

DLA component 460 may perform policy learning and policy adaptation operations, including a continuous refinement of logging policies based on the effectiveness of past decisions, e.g., based on analysis provided by historical analysis component 470. In different implementations, DLA component 460 may provide adaptive logging component 450 with moment-to-moment instructions on how to adjust log configuration 269. DLA component 460 also feeds back information to historical analysis component 470 about the effectiveness of log configuration adjustments, e.g., improving long-term learning and improvement of logging processes.

In one or more embodiments, historical analysis component 470 stores, processes, and analyzes historical log data and contextual information to identify patterns, trends, and anomalies over extended periods. Different operations performed by historical analysis component 470 include data storage and indexing, and pattern recognition. Pattern recognition operations may include long-term trend analysis (e.g., identifying patterns in application behavior over days, weeks, or months) and seasonality detection, e.g., identifying cyclical patterns in application usage or performance. In some implementations, historical analysis component 470 provides historical data to DLA component 460 for use determining adjustments to the configuration of logging parameters. The operation and functions of historical analysis component 470 are further discussed with FIG. 6 below.

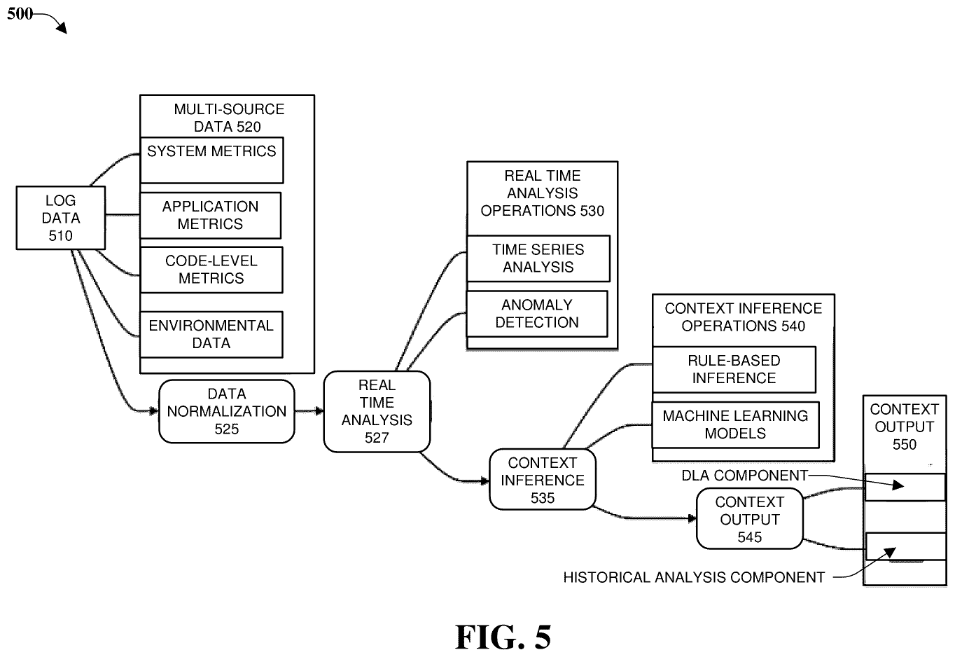

Machine learning component 480 may use different machine learning operations to generate and maintain process model 166. Additional discussion of machine learning operations by embodiments are included with FIGS. 5 and 6 below.

In an example, one or more embodiments can operate in a loop of improvement. For example, the context component 320 may monitors process 315, and provides real-time context to DLA component 460. DLA component 460 may combine this real-time context with historical insights from historical analysis component 470 to make logging determinations. The logging determinations may be implemented by adaptive logging component 450. Adaptive logging component 450 may adjust the logging configuration based on the logging determinations. The resulting logs may be stored and indexed by LSR component 440. Historical analysis component 470 may analyze the stored logs and their usage patterns, and may update historical models, and provide additional information to DLA component 460. In different implementations, this cycle may continue, with the operation of components being adapted based on the evolving operation of the application, and the effectiveness of past logging decisions.

FIG. 5 is an architecture diagram 500 of a context inference component that can facilitate predictive, context-responsive logging of the operation of a process, in accordance with one or more embodiments. For purposes of brevity, description of like elements and/or processes employed in other embodiments is omitted.

Generally speaking, one or more embodiments may gather and analyze real-time data from the application environment (e.g., process 175 and process 275) by employing a multi-layered approach to data collection and processing, thereby improving an understanding of the current operational context of the application environment being logged.

In one or more embodiments, as depicted in FIG. 1, adjusting component 128 may determine adjustments to log configuration 168 by employing context inference component 330. In an alternative embodiment, as depicted in FIG. 2, adjustor 226 may determine adjustment 281 to log configuration 269 by employing context inference component 330. As depicted, example context detection engine includes log data 510, data normalization 525, real-time analysis 527, context inference 535, and context output 545.

Log data 510 may include multi-source data 520. Data collected from multiple sources may include but are not limited to, system-level metrics, application-level metrics, code-level instrumentation, and environmental data. System-level metrics include but are not limited to, CPU usage, memory consumption, disk I/O, and network traffic. For example, CPU Usage may be monitored by embodiments to identify periods of high computational demand. Memory consumption may be tracked by embodiments to detect memory-intensive operations. Disk I/O may be measured by embodiments to monitor read/write operations that may indicate heavy data processing. Network traffic may be observed by embodiments to understand data transfer rates and potential network bottlenecks.

Application-level metrics include but are not limited to, request rate, response times, error rates, and active user sessions. Request rate, the number of requests received per unit time, may be used by embodiments to indicate application load. Response time, the time taken to process requests, may be used by embodiments for identifying performance issues. Error Rates, the frequency of errors occurring, may be used by embodiments to highlight potential problems. Active user sessions, measured by the number of concurrent users, may indicate to embodiments the user load and engagement.

Code-level instrumentation includes but are not limited to, method invocations, exception occurrences, and custom application events. In an implementation, method invocations may include tracking calls to critical methods that can highlight to embodiments which parts of the code are most active. Monitoring exception occurrences may facilitate an analysis by embodiments of error patterns. Custom (e.g., application-specific) events may provide additional context for embodiments.

Environmental data include but are not limited to, time of day, day of week, and deployment environment (e.g., production, staging, etc.). For example, certain operations may be time-sensitive or follow specific schedules. User behavior and system load can vary significantly between weekdays and weekends. Differentiating between different deployment environments (e.g., production, staging, and development) may facilitate the application by embodiments of appropriate logging strategies for different environments.

Data normalization 525 may include operations that involve, but are not limited to, conversion of raw metrics into standardized formats for consistent analysis. Real-time analysis 527 may include real-time analysis operations 530 that involve, but are not limited to, time series analysis and anomaly detection. In an implementation, time-series analysis includes identifying short-term trends and patterns, and anomaly detection employs statistical methods (e.g., Z-score analysis, DBSCAN clustering) to identify outliers in real-time data. In one or more embodiments, anomaly classification performed during real-time analysis may by based on a catalog of known issues and their corresponding contexts maintained by embodiments. Additionally, embodiments may classify new anomalies and link the anomalies to similar past occurrences.

Context inference 535 may include context inference operations 540 that involve but are not limited to, rule-based inference and machine learning model operations. In an implementation, rule-based inference includes applying predefined rules to map metric combinations to specific contexts.

For example, predefined rules may be applied to different hardware conditions. In an example, a CPU Usage Rule may provide that when the CPU usage system metric is greater than 80% and request rate is greater than 1000/min, then the application context may be labelled as a “high_load” context. In another example, an error rate rule may provide that when the error rate system metric is greater than 5%, then the application context may be labelled as an “error_prone” context. In another example, a memory usage rule may provide that when the memory usage system metric is greater than 90%, then the application context may be labelled as a “memory_constrained” context. In another example, a concurrent users rule may provide that when the active users system metric is greater than 10000, then the application context may be labelled as a “high_traffic” context.

Machine Learning model context inference operations may include approaches such as the use of Random Forest classifiers and unsupervised learning techniques (e.g., K-means clustering) to categorize the current context and potentially discover new, previously undefined contexts. In an implementation, models such as Random Forest models may be employed for their ability to handle non-linear relationships and determine feature importance.

FIG. 6 is an architecture diagram of a historical analysis module 600 that can facilitate predictive, context-responsive logging of the operation of a process, in accordance with one or more embodiments. For purposes of brevity, description of like elements and/or processes employed in other embodiments is omitted.

In one or more embodiments, machine learning integration 645 may provide context detection identifying complex operational states. In an example, machine learning integration 645 may include, but are not limited to, supervised learning, unsupervised learning, and reinforcement learning. In an implementation, supervised learning includes training models to predict future application states based on historical data.

In an implementation, training a machine learning model may include data collection, feature engineering, model selection, splitting data into training and validation sets, and validating model performance. Additional operations may include tuning hyperparameters and cross-validating models. Once created, models may be periodically retrained with new data to adapt to evolving application behavior.

In an implementation, unsupervised learning includes discovering hidden patterns or clusters in historical data. In an implementation, reinforcement learning includes continuously improving logging policies based on the usefulness of past logs.

In an embodiment, pattern recognition 630 may predict potential issues before they occur. Different approaches to pattern recognition include long-term trend analysis, e.g., identifying patterns in application behavior over days, weeks, or months. Pattern recognition may also include seasonality detection, e.g., recognizing cyclical patterns in application usage or performance. One or more embodiments may continuously learn from new data and feedback to refine its log configuration 269. Reinforcement learning processes may enable embodiments to adapt to evolving application behaviors.

One or more embodiments may be used for scenario recreation, e.g., context tagging, log chaining, and replay functionality. In an implementation, for debugging processes, scenario recreation may facilitate tracing and recreating the sequence of events leading to an issue. For example, context tagging may be used to tag log entries with a detected context, e.g., facilitating filtering and reconstruction of the state of an application at different times. A log chaining mechanism may be used by embodiments, where related log entries across different components or services are automatically linked using unique correlation IDs. Adaptive verbosity with backtracking may be enabled by embodiments by maintaining a rolling buffer of more detailed logs. If an issue is detected, one or more embodiments can backtrack and persist the detailed logs, e.g., reducing the likelihood that critical information is lost.

At key points or on-demand, one or more embodiments can capture and store snapshots of the application's state, and these snapshots may be used in conjunction with logs to recreate scenarios more accurately. One or more embodiments include a replay feature that can simulate the operation of an application based on historical logs and context data, e.g., facilitating a step through of scenarios for debugging purposes. In one or more embodiments, log entries may include metadata about the origin of the log entry (e.g., file, line number, and thread ID), as well as the logging configuration that led to the creation of the log entry, thereby improving traceability even with dynamic logging behavior. One or more embodiments may maintain a baseline level of logging to improve consistency, while dynamically adjusting logging strategies to also improve performance and resource usage.

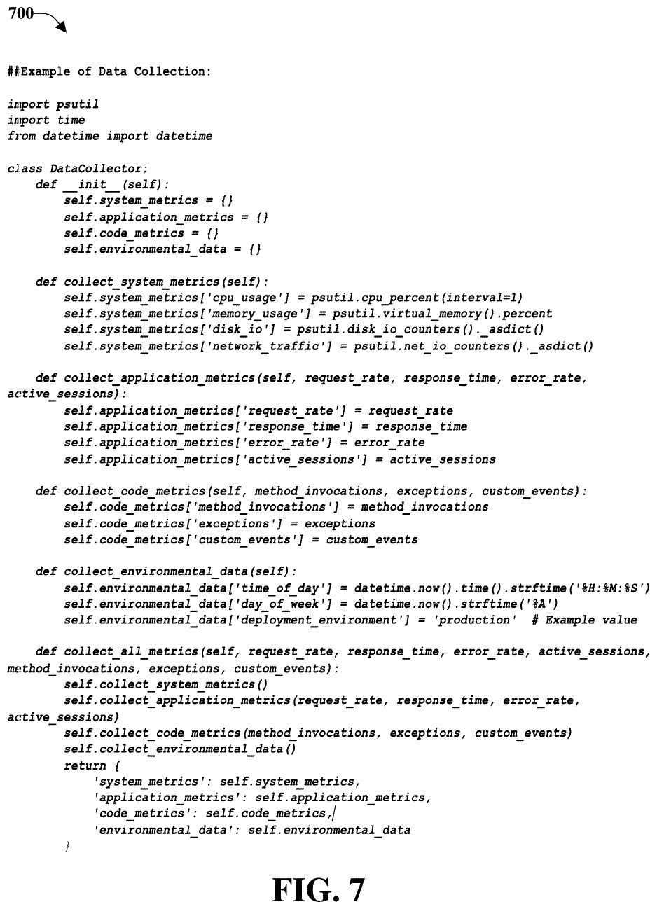

FIG. 7 depicts example code 700 for a system that can be used to facilitate predictive, context-responsive logging of the operation of a process, in accordance with one or more embodiments. In an example, code 700 may include computer-executable instructions of a computer program that are executable by a processor to cause the processor to perform different operations described herein. For purposes of brevity, description of like elements and/or processes employed in other embodiments is omitted.

As depicted, code 700 includes example computer-executable instructions to cause a processor to collect data. Code 700 may be usable to perform operations for any computer-executable components described herein. In an implementation, code 700 may be used by logging equipment 150 and 250 to implement components including, but not limited to, monitoring component 122 and receiver 222. In an additional or alternative implementation, code 700 may be used by monitoring equipment 280 to facilitate monitoring the operation of process 275, resulting in log data 282.

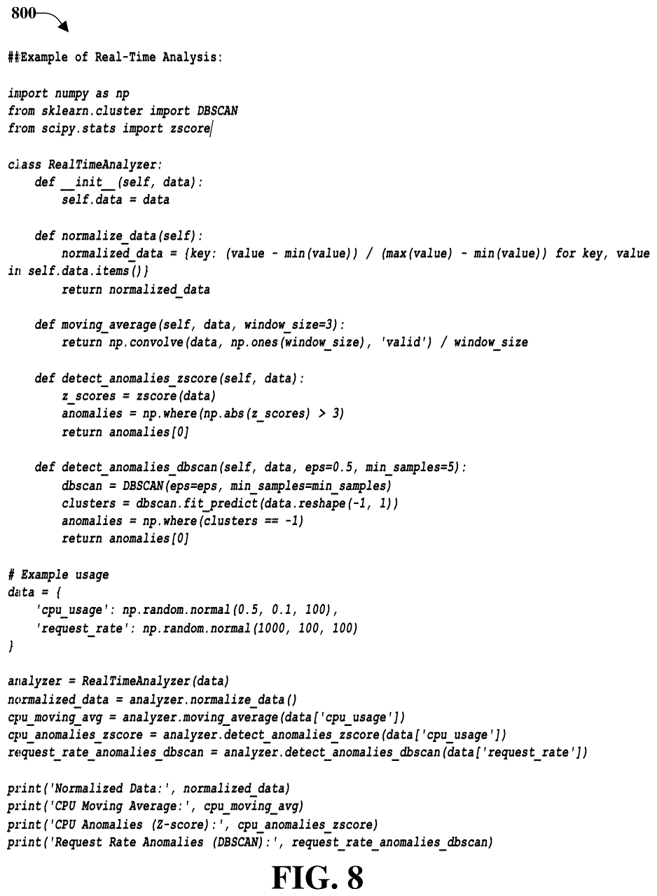

FIG. 8 depicts example code 800 for a system that can be used to facilitate predictive, context-responsive logging of the operation of a process, in accordance with one or more embodiments. In an example, code 800 may include computer-executable instructions of a computer program that are executable by a processor to cause the processor to perform different operations described herein. For purposes of brevity, description of like elements and/or processes employed in other embodiments is omitted.

As depicted, code 800 includes example computer-executable instructions to cause a processor to perform real-time analysis of log data 282. Code 800 may be usable to perform operations for any computer-executable components described herein. In an implementation, code 800 may be used by logging equipment 150 and 250 to implement components including, but not limited to, logging component 122 and predictor 224.

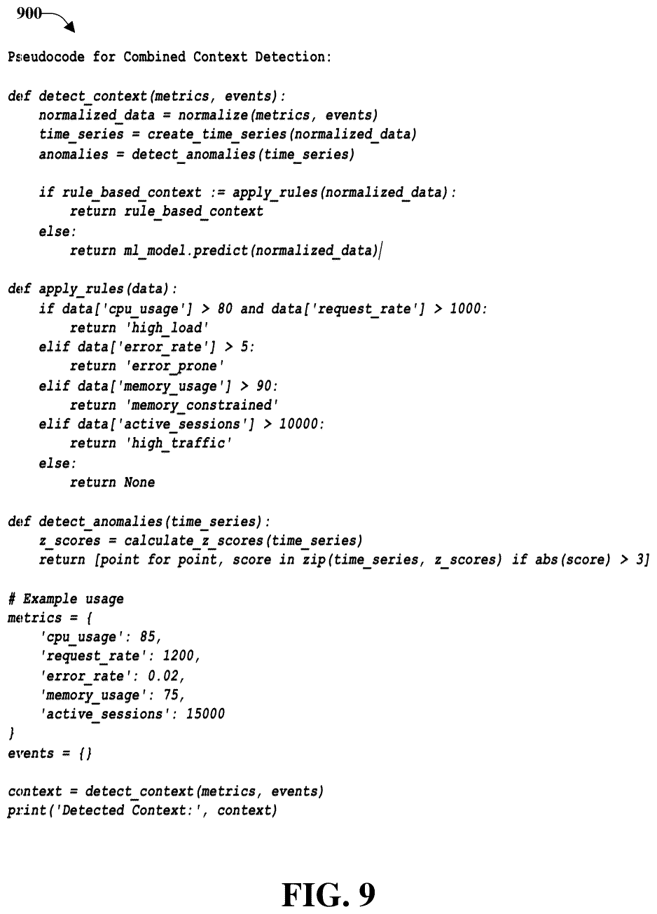

FIG. 9 depicts example code 900 for a system that can be used to facilitate predictive, context-responsive logging of the operation of a process, in accordance with one or more embodiments. In an example, code 900 may include computer-executable instructions of a computer program that are executable by a processor to cause the processor to perform different operations described herein. For purposes of brevity, description of like elements and/or processes employed in other embodiments is omitted.

As depicted, code 900 includes example pseudocode for computer-executable instructions that cause a processor to perform combined context detection operations for analyzing real-time analysis of log data 282. Code 800 may be usable to perform operations for any computer-executable components described herein. In an implementation, code 800 may be used by logging equipment 150 and 250 to implement components including, but not limited to, logging component 122 and predictor 224.

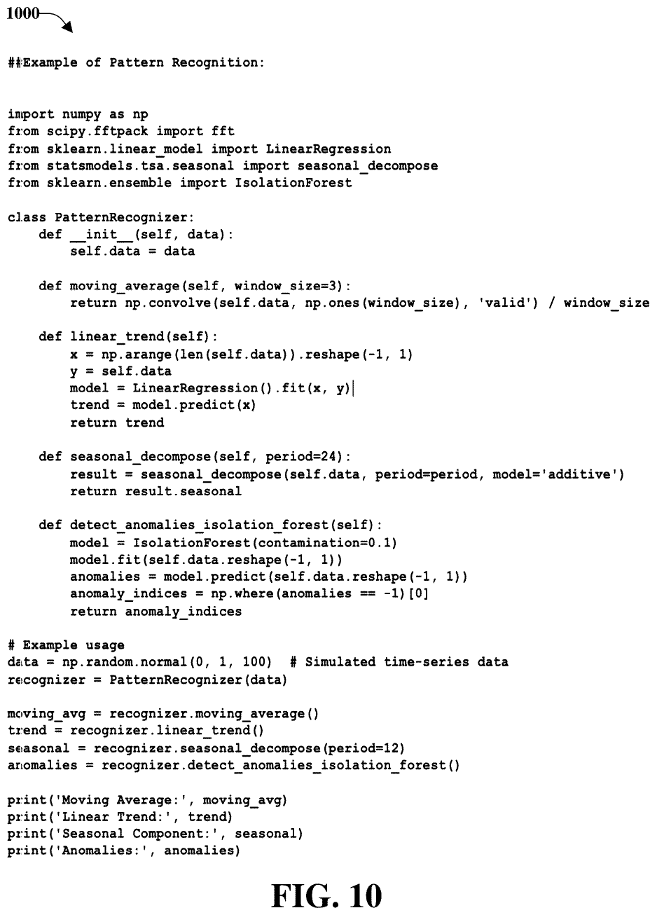

FIG. 10 depicts example code 1000 for a system that can be used to facilitate predictive, context-responsive logging of the operation of a process, in accordance with one or more embodiments. In an example, code 1000 may include computer-executable instructions of a computer program that are executable by a processor to cause the processor to perform different operations described herein. For purposes of brevity, description of like elements and/or processes employed in other embodiments is omitted.

As depicted, code 1000 includes example pseudocode for computer-executable instructions that cause a processor to perform combined context detection operations for real-time analysis of log data 282. Code 1000 may be usable to perform operations for any computer-executable components described herein. In an implementation, code 800 may be used by logging equipment 150 and 250 to implement components including, but not limited to, logging component 122 and predictor 224.

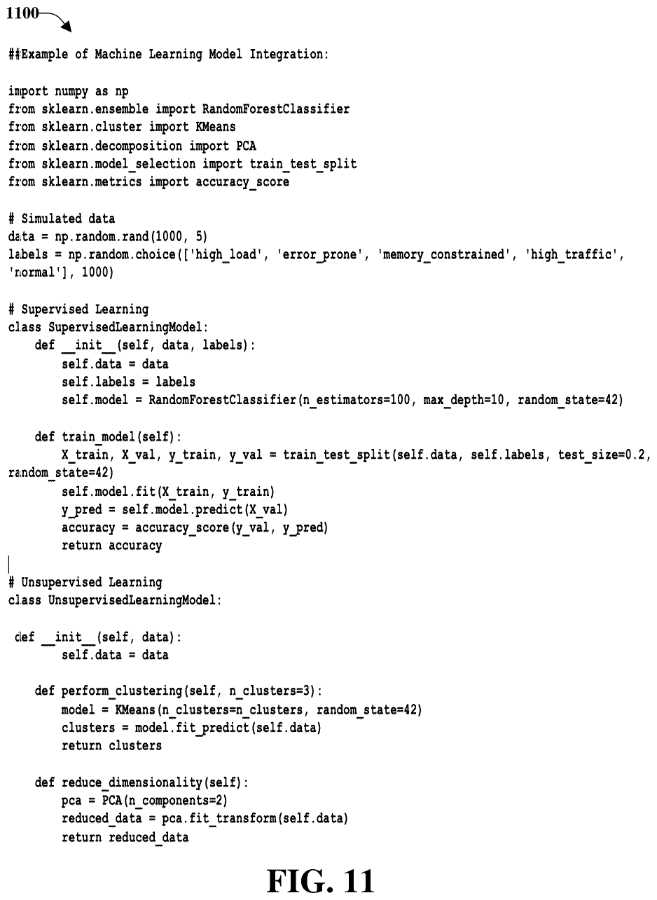

FIG. 11 depicts example code 1100 for a system that can be used to facilitate predictive, context-responsive logging of the operation of a process, in accordance with one or more embodiments. In an example, code 1100 may include computer-executable instructions of a computer program that are executable by a processor to cause the processor to perform different operations described herein. For purposes of brevity, description of like elements and/or processes employed in other embodiments is omitted.

As depicted, code 1100 includes example pseudocode for computer-executable instructions that cause a processor to perform machine learning model operations. In an implementation, code depicted in FIG. 11 may be used to implement machine learning component 480, as well as generate and maintain process model. 166.

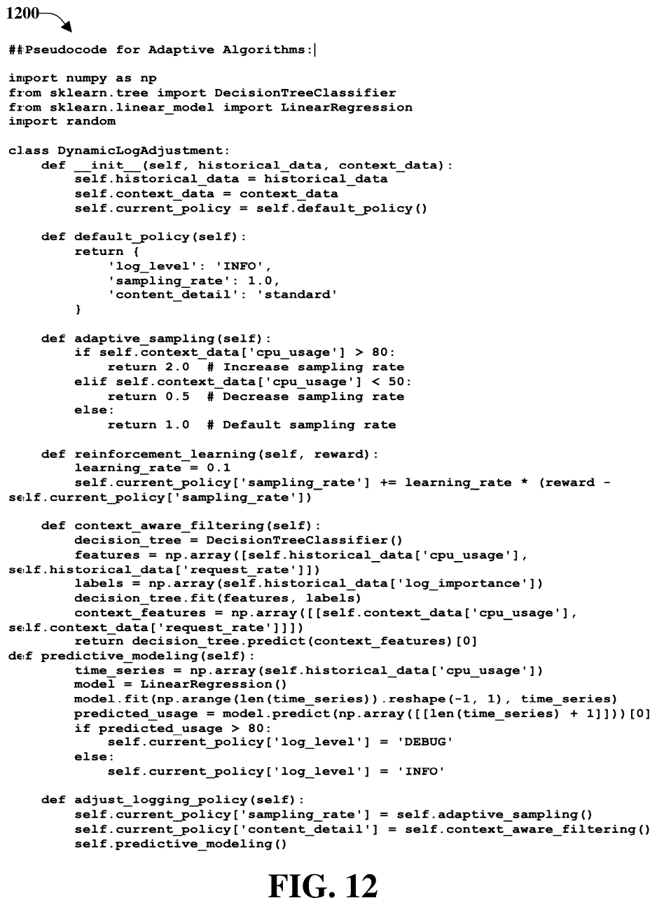

FIG. 12 depicts example code 1200 for a system that can be used to facilitate predictive, context-responsive logging of the operation of a process, in accordance with one or more embodiments. In an example, code 1200 may include computer-executable instructions of a computer program that are executable by a processor to cause the processor to perform different operations described herein. For purposes of brevity, description of like elements and/or processes employed in other embodiments is omitted.

As depicted, code 1200 includes example pseudocode for computer-executable instructions that cause a processor to perform combined context detection operations for dynamic log adjustment operations. In an implementation, code depicted in FIG. 12 may be used to implement DLA component 460 and generate adjustment 281.

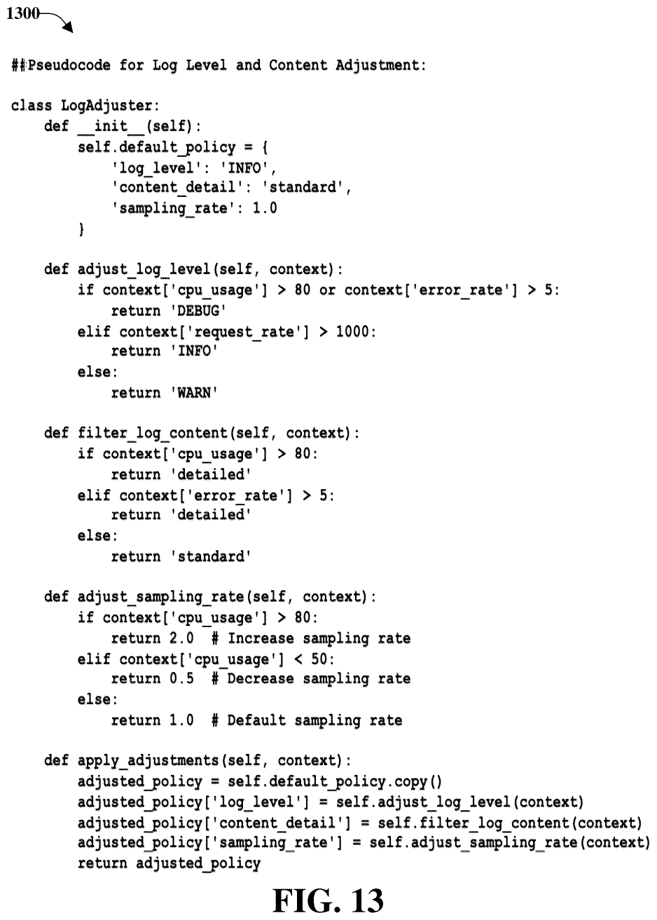

FIG. 13 depicts example code 1300 for a system that can be used to facilitate predictive, context-responsive logging of the operation of a process, in accordance with one or more embodiments. In an example, code 1300 may include computer-executable instructions of a computer program that are executable by a processor to cause the processor to perform different operations described herein. For purposes of brevity, description of like elements and/or processes employed in other embodiments is omitted.

As depicted, code 1300 includes example pseudocode for computer-executable instructions that cause a processor to perform operations for adjusting different logging parameters. As shown in the code, parameters that affect log level and content analyzed are modified. In one or more embodiments, these parameter changes may be included in adjustment 281 generated by DLA component 460.

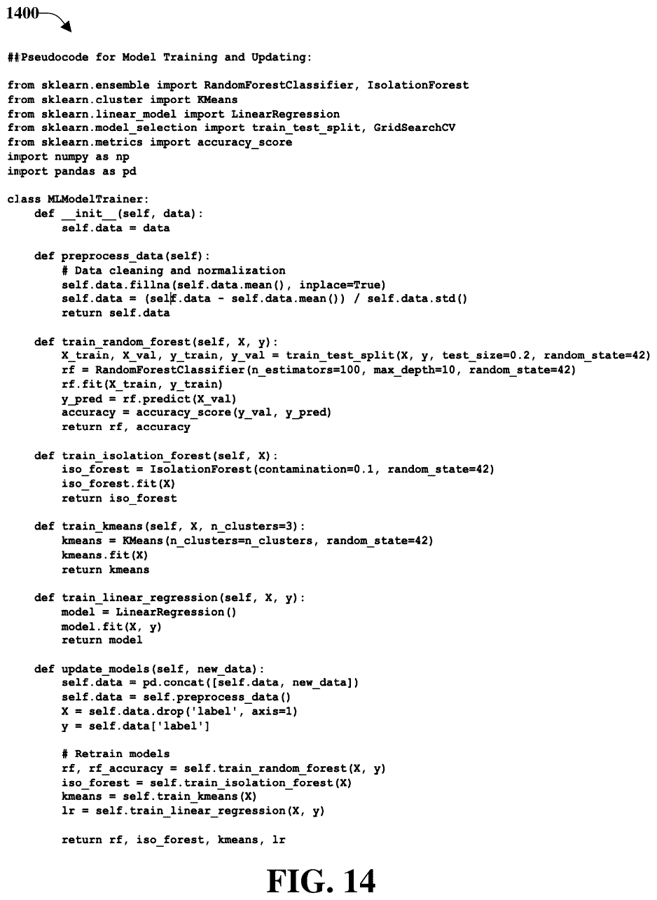

FIG. 14 depicts example code 1400 for a system that can be used to facilitate predictive, context-responsive logging of the operation of a process, in accordance with one or more embodiments. In an example, code 1400 may include computer-executable instructions of a computer program that are executable by a processor to cause the processor to perform different operations described herein. For purposes of brevity, description of like elements and/or processes employed in other embodiments is omitted.

As depicted, code 1400 includes example pseudocode for computer-executable instructions that cause a processor to perform operations for training and updating a model that may be used by embodiments. For example, code 1400 may be used to implement machine learning component 480 to train and update process model 166.

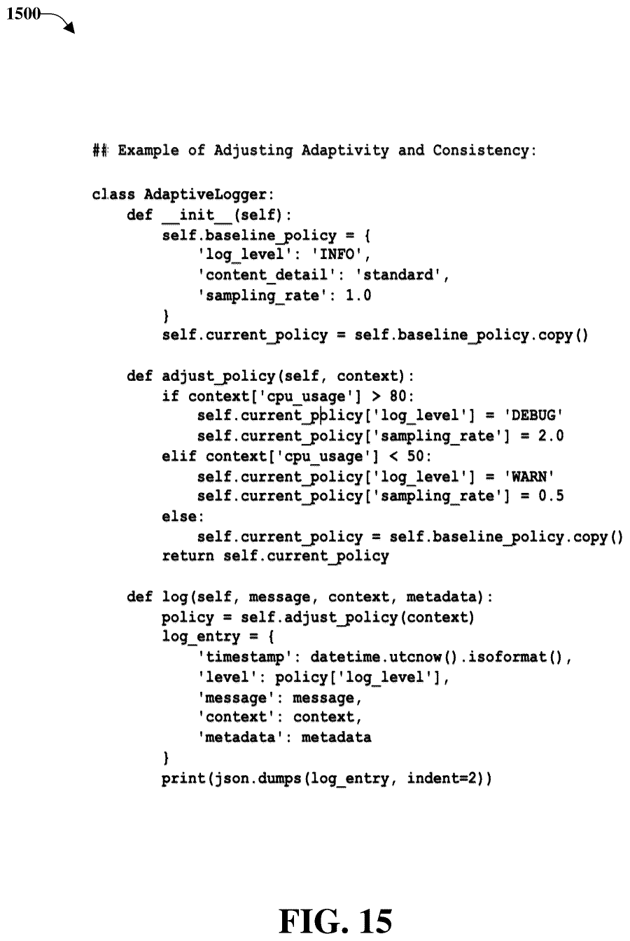

FIG. 15 depicts example code 1500 for a system that can be used to facilitate predictive, context-responsive logging of the operation of a process, in accordance with one or more embodiments. In an example, code 1500 may include computer-executable instructions of a computer program that are executable by a processor to cause the processor to perform different operations described herein. For purposes of brevity, description of like elements and/or processes employed in other embodiments is omitted.

As depicted, code 1500 includes example pseudocode for computer-executable instructions that cause a processor to perform operations for adjusting adaptivity and consistency of log configurations. For example, code 1500 may be used to implement DLA component 460, so that adjustments to logging parameters are changed with appropriate frequence, and are consistent with other adjustments.

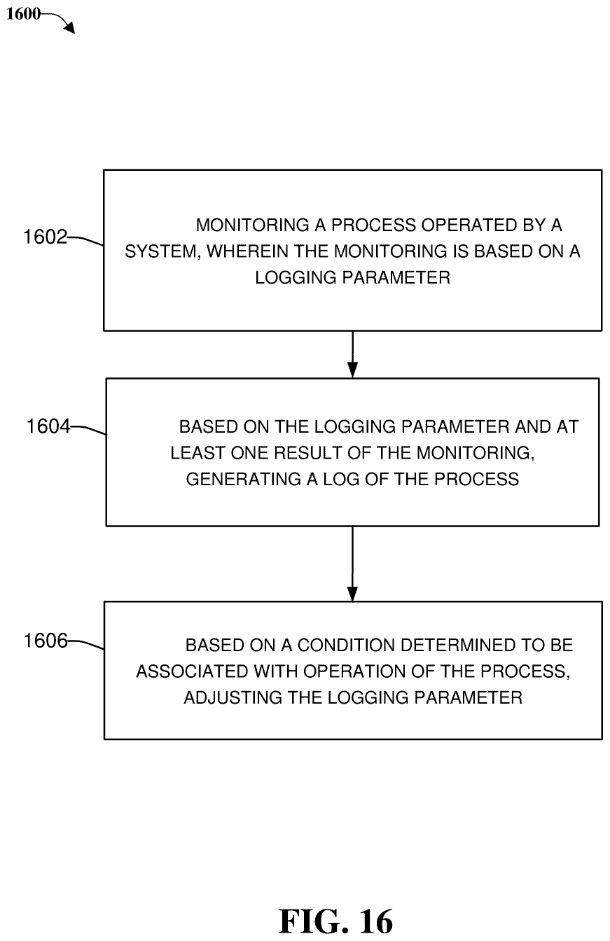

FIG. 16 depicts a flow diagram representing example operations of an example method 1600 that can facilitate predictive, context-responsive logging of the operation of a process, in accordance with one or more embodiments. For purposes of brevity, description of like elements and/or processes employed in other embodiments is omitted.

In some examples, one or more embodiments of method 1600 can be implemented by monitoring component 122, logging component 124, adjusting component 126, and other components that can be used to implement aspects of method 1600, in accordance with one or more embodiments. It is appreciated that the operating procedures of method 1600 are example operating procedures, and that there can be embodiments that implement more or fewer operating procedures than are depicted, or that implement the depicted operating procedures in a different order than as depicted.

At 1602 of method 1600, monitoring component 122 of logging equipment 150 can, in one or more embodiments, monitor a process operated by a system, with the monitoring being based on a logging parameter. At 1604 of method 1600, logging component 124 can, in one or more embodiments, based on the logging parameter and at least one result of the monitoring, generate a log of the process. At 1606 of method 1600, adjusting component 126 can, in one or more embodiments, based on a condition determined to be associated with operation of the process, adjust the logging parameter.

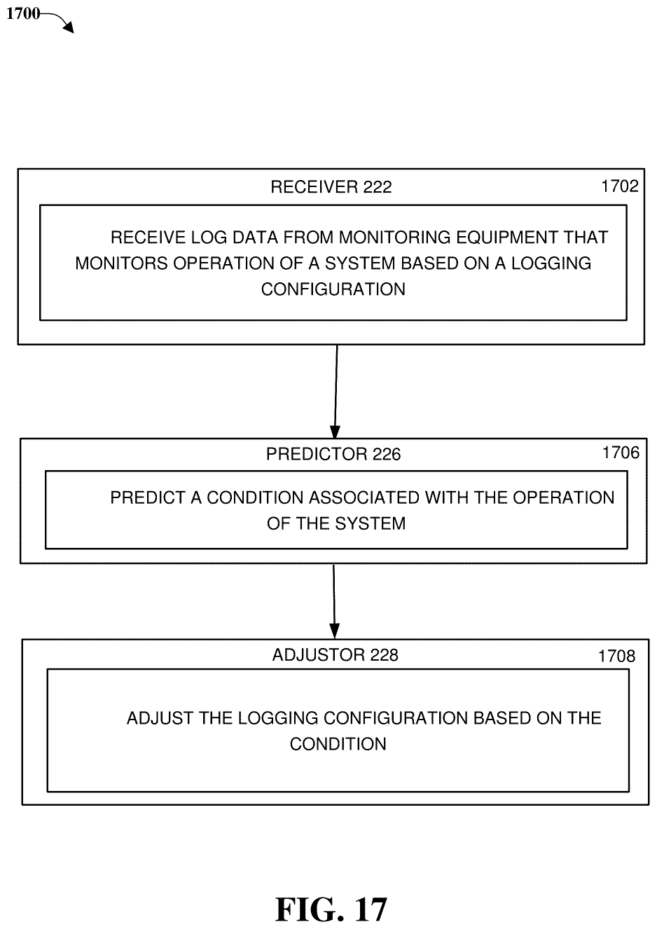

FIG. 17 depicts an example system 1700 that can facilitate predictive, context-responsive logging of the operation of a process, in accordance with one or more embodiments. For purposes of brevity, description of like elements and/or processes employed in other embodiments is omitted. Example system 1700 can include receiver 222, predictor 224, adjustor 226, and other components that can be used to implement aspects of system 1700, as described herein, in accordance with one or more embodiments.

At 1702 of FIG. 17, receiver 222 can receive log data from monitoring equipment that monitors operation of a system based on a logging configuration. At 1704 of FIG. 17, predictor 224 can predict a condition associated with the operation of the system. At 1706 of FIG. 17, adjustor 226 can adjust the logging configuration based on the condition.

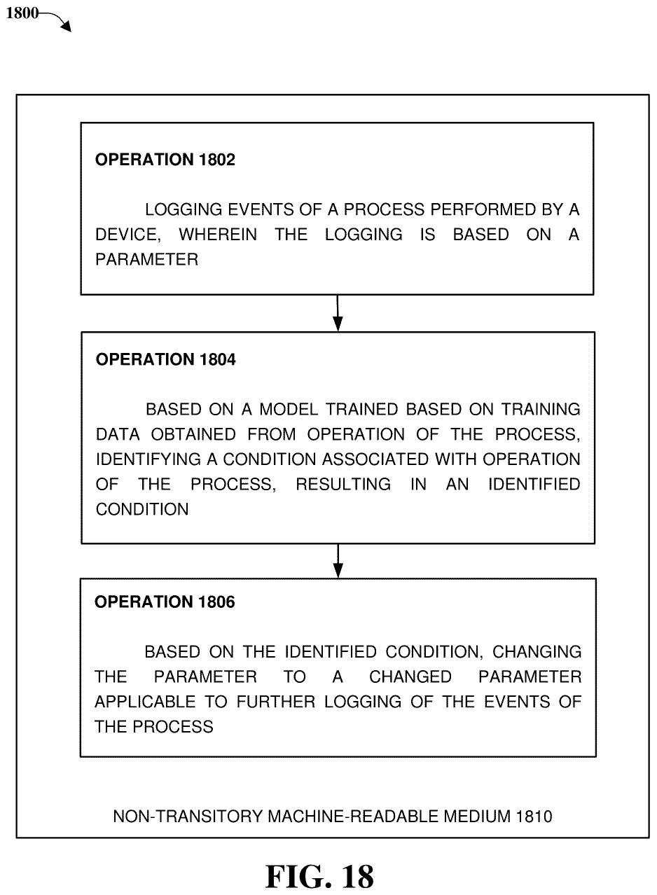

FIG. 18 depicts an example 1800 non-transitory machine-readable medium 1810 that can include executable instructions that, when executed by a processor of a system, can facilitate predictive, context-responsive logging of the operation of a process, in accordance with one or more embodiments. For purposes of brevity, description of like elements and/or processes employed in other embodiments is omitted.

Operation 1802 of FIG. 18 can facilitate generation of monitoring component 122 which, in one or more embodiments, can log events of a process performed by a device, with the logging being based on a parameter. Operation 1804 of FIG. 18 can facilitate generation of logging component 124, which, in one or more embodiments can, based on a model trained based on training data obtained from operation of the process, identify a condition associated with operation of the process, resulting in an identified condition. Operation 1806 of FIG. 18 can facilitate generation of adjusting component 126 which, in one or more embodiments, can, based on the identified condition, change the parameter to a changed parameter applicable to further logging of the events of the process.

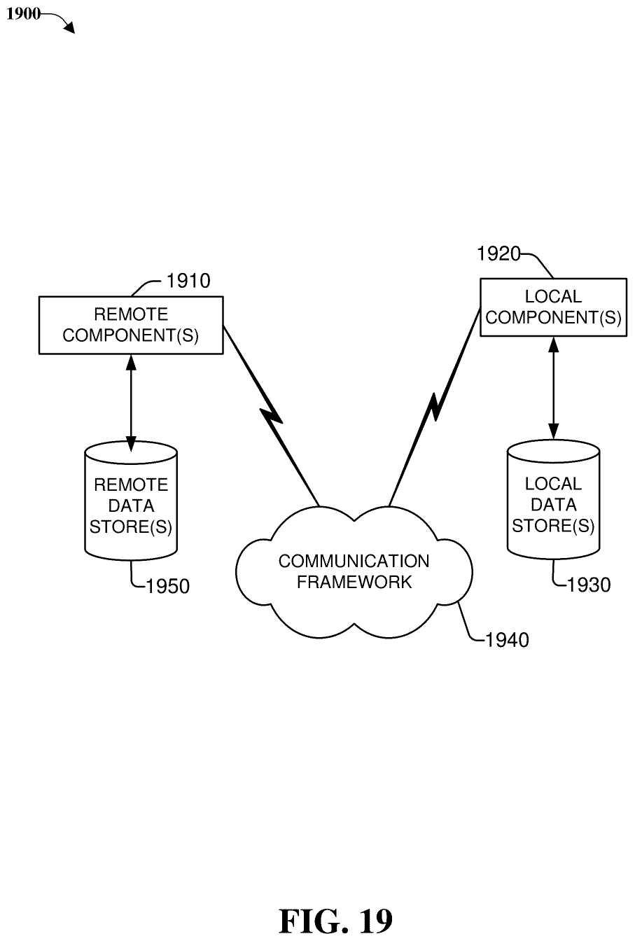

FIG. 19 is a schematic block diagram of a system 1900 with which the disclosed subject matter can interact. The system 1900 comprises one or more remote component(s) 1910. The remote component(s) 1910 can be hardware and/or software (e.g., threads, processes, computing devices). In some embodiments, remote component(s) 1910 can be a distributed computer system, connected to a local automatic scaling component and/or programs that use the resources of a distributed computer system, via communication framework 1940. Communication framework 1940 can comprise wired network devices, wireless network devices, mobile devices, wearable devices, radio access network devices, gateway devices, femtocell devices, servers, etc.

The system 1900 also comprises one or more local component(s) 1920. The local component(s) 1920 can be hardware and/or software (e.g., threads, processes, computing devices).

One possible communication between a remote component(s) 1910 and a local component(s) 1920 can be in the form of a data packet adapted to be transmitted between two or more computer processes. Another possible communication between a remote component(s) 1910 and a local component(s) 1920 can be in the form of circuit-switched data adapted to be transmitted between two or more computer processes in radio time slots. The system 1900 comprises a communication framework 1940 that can be employed to facilitate communications between the remote component(s) 1910 and the local component(s) 1920, and can comprise an air interface, e.g., Uu interface of a UMTS network, via a long-term evolution (LTE) network, etc. Remote component(s) 1910 can be operably connected to one or more remote data store(s) 1950, such as a hard drive, solid state drive, SIM card, device memory, etc., that can be employed to store information on the remote component(s) 1910 side of communication framework 1940. Similarly, local component(s) 1920 can be operably connected to one or more local data store(s) 1930, that can be employed to store information on the local component(s) 1920 side of communication framework 1940.

In order to provide a context for the various aspects of the disclosed subject matter, the following discussion is intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that performs particular tasks and/or implement particular abstract data types.

In the subject specification, terms such as “store,” “storage,” “data store,” “data storage,” “database,” and substantially any other information storage component relevant to operation and functionality of a component, refer to “memory components,” or entities embodied in a “memory” or components comprising the memory. It is noted that the memory components described herein can be either volatile memory or non-volatile memory, or can comprise both volatile and non-volatile memory, for example, by way of illustration, and not limitation, volatile memory 2020 (see below), non-volatile memory 2022 (see below), disk storage 2024 (see below), and memory storage, e.g., local data store(s) 1930 and remote data store(s) 1950, see below. Further, nonvolatile memory can be included in read only memory, programmable read only memory, electrically programmable read only memory, electrically erasable read only memory, or flash memory. Volatile memory can comprise random access memory, which acts as external cache memory. By way of illustration and not limitation, random access memory is available in many forms such as synchronous random-access memory, dynamic random access memory, synchronous dynamic random access memory, double data rate synchronous dynamic random access memory, enhanced synchronous dynamic random access memory, SynchLink dynamic random access memory, and direct Rambus random access memory. Additionally, the disclosed memory components of systems or methods herein are intended to comprise, without being limited to comprising, these and any other suitable types of memory.

Moreover, it is noted that the disclosed subject matter can be practiced with other computer system configurations, comprising single-processor or multiprocessor computer systems, mini-computing devices, mainframe computers, as well as personal computers, hand-held computing devices (e.g., personal digital assistant, phone, watch, tablet computers, netbook computers), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

Referring now to FIG. 20, in order to provide additional context for various embodiments described herein, FIG. 20 and the following discussion are intended to provide a brief, general description of a suitable computing environment 2000 in which the various embodiments described herein can be implemented.

While the embodiments have been described above in the general context of computer-executable instructions that can run on one or more computers, those skilled in the art will recognize that the embodiments can be also implemented in combination with other program modules and/or as a combination of hardware and software. For purposes of brevity, description of like elements and/or processes employed in other embodiments is omitted.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, Internet of Things (IOT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 20, the example environment 2000 for implementing various embodiments of the aspects described herein includes a computer 2002, the computer 2002 including a processing unit 2004, a system memory 2006 and a system bus 2008. The system bus 2008 couples system components including, but not limited to, the system memory 2006 to the processing unit 2004. The processing unit 2004 can be any of various commercially available processors. Dual microprocessors and other multi-processor architectures can also be employed as the processing unit 2004.

The system bus 2008 can be any of several types of bus structure that can further interconnect to a memory bus (with or without a memory controller), a peripheral bus, and a local bus using any of a variety of commercially available bus architectures. The system memory 2006 includes ROM 2010 and RAM 2012. A basic input/output system (BIOS) can be stored in a non-volatile memory such as ROM, erasable programmable read only memory (EPROM), EEPROM, which BIOS contains the basic routines that help to transfer information between elements within the computer 2002, such as during startup. The RAM 2012 can also include a high-speed RAM such as static RAM for caching data.

The computer 2002 further includes an internal hard disk drive (HDD) 2014 (e.g., EIDE, SATA), one or more external storage devices 2016 (e.g., a magnetic floppy disk drive (FDD) 2016, a memory stick or flash drive reader, a memory card reader, etc.) and an optical disk drive 2020 (e.g., which can read or write from a CD-ROM disc, a DVD, a BD, etc.). While the internal HDD 2014 is illustrated as located within the computer 2002, the internal HDD 2014 can also be configured for external use in a suitable chassis (not shown). Additionally, while not shown in environment 2000, a solid-state drive (SSD) could be used in addition to, or in place of, an HDD 2014. The HDD 2014, external storage device(s) 2016 and optical disk drive 2020 can be connected to the system bus 2008 by an HDD interface 2024, an external storage interface 2026 and an optical drive interface 2028, respectively. The interface 2024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 2002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 2012, including an operating system 2030, one or more application programs 2032, other program modules 2034 and program data 2036. All or portions of the operating system, applications, modules, and/or data can also be cached in the RAM 2012. The systems and methods described herein can be implemented utilizing various commercially available operating systems or combinations of operating systems.

Computer 2002 can optionally comprise emulation technologies. For example, a hypervisor (not shown) or other intermediary can emulate a hardware environment for operating system 2030, and the emulated hardware can optionally be different from the hardware illustrated in FIG. 20. In such an embodiment, operating system 2030 can comprise one virtual machine (VM) of multiple VMs hosted at computer 2002. Furthermore, operating system 2030 can provide runtime environments, such as the Java runtime environment or the .NET framework, for applications 2032. Runtime environments are consistent execution environments that allow applications 2032 to run on any operating system that includes the runtime environment. Similarly, operating system 2030 can support containers, and applications 2032 can be in the form of containers, which are lightweight, standalone, executable packages of software that include, e.g., code, runtime, system tools, system libraries and settings for an application.

Further, computer 2002 can be enabled with a security module, such as a trusted processing module (TPM). For instance, with a TPM, boot components hash next in time boot components, and wait for a match of results to secured values, before loading a next boot component. This process can take place at any layer in the code execution stack of computer 2002, e.g., applied at the application execution level or at the operating system (OS) kernel level, thereby enabling security at any level of code execution.

A user can enter commands and information into the computer 2002 through one or more wired/wireless input devices, e.g., a keyboard 2038, a touch screen 2040, and a pointing device, such as a mouse 2042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 2004 through an input device interface 2044 that can be coupled to the system bus 2008, but can be connected by other interfaces, such as a parallel port, an IEEE 1394 serial port, a game port, a USB port, an IR interface, a BLUETOOTH® interface, etc.

A monitor 2046 or other type of display device can be also connected to the system bus 2008 via an interface, such as a video adapter 2048. In addition to the monitor 2046, a computer typically includes other peripheral output devices (not shown), such as speakers, printers, etc.

The computer 2002 can operate in a networked environment using logical connections via wired and/or wireless communications to one or more remote computers, such as a remote computer(s) 2050. The remote computer(s) 2050 can be a workstation, a server computer, a router, a personal computer, portable computer, microprocessor-based entertainment appliance, a peer device or other common network node, and typically includes many or all of the elements described relative to the computer 2002, although, for purposes of brevity, only a memory/storage device 2052 is illustrated. The logical connections depicted include wired/wireless connectivity to a local area network (LAN) 2054 and/or larger networks, e.g., a wide area network (WAN) 2056. Such LAN and WAN networking environments are commonplace in offices and companies, and facilitate enterprise-wide computer networks, such as intranets, all of which can connect to a global communications network, e.g., the Internet.

When used in a LAN networking environment, the computer 2002 can be connected to the local network 2054 through a wired and/or wireless communication network interface or adapter 2058. The adapter 2058 can facilitate wired or wireless communication to the LAN 2054, which can also include a wireless access point (AP) disposed thereon for communicating with the adapter 2058 in a wireless mode.

When used in a WAN networking environment, the computer 2002 can include a modem 2060 or can be connected to a communications server on the WAN 2056 via other means for establishing communications over the WAN 2056, such as by way of the Internet. The modem 2060, which can be internal or external and a wired or wireless device, can be connected to the system bus 2008 via the input device interface 2044. In a networked environment, program modules depicted relative to the computer 2002 or portions thereof, can be stored in the remote memory/storage device 2052. It will be appreciated that the network connections shown are example and other means of establishing a communications link between the computers can be used.

When used in either a LAN or WAN networking environment, the computer 2002 can access cloud storage systems or other network-based storage systems in addition to, or in place of, external storage devices 2016 as described above. Generally, a connection between the computer 2002 and a cloud storage system can be established over a LAN 2054 or WAN 2056 e.g., by the adapter 2058 or modem 2060, respectively. Upon connecting the computer 2002 to an associated cloud storage system, the external storage interface 2026 can, with the aid of the adapter 2058 and/or modem 2060, manage storage provided by the cloud storage system as it would other types of external storage. For instance, the external storage interface 2026 can be configured to provide access to cloud storage sources as if those sources were physically connected to the computer 2002.

The computer 2002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations”, this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or API components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms like “user equipment (UE),” “mobile station,” “mobile,” subscriber station,” “subscriber equipment,” “access terminal,” “terminal,” “handset,” and similar terminology, refer to a wireless device utilized by a subscriber or user of a wireless communication service to receive or convey data, control, voice, video, sound, gaming, or substantially any data-stream or signaling-stream. The foregoing terms are utilized interchangeably in the subject specification and related drawings. Likewise, the terms “network device,” “access point (AP),” “base station,” “NodeB,” “evolved Node B (eNodeB),” “home Node B (HNB),” “home access point (HAP),” “cell device,” “sector,” “cell,” and the like, are utilized interchangeably in the subject application, and refer to a wireless network component or appliance that can serve and receive data, control, voice, video, sound, gaming, or substantially any data-stream or signaling-stream to and from a set of subscriber stations or provider enabled devices. Data and signaling streams can include packetized or frame-based flows.

Additionally, the terms “core-network”, “core”, “core carrier network”, “carrier-side”, or similar terms can refer to components of a telecommunications network that typically provides some or all of aggregation, authentication, call control and switching, charging, service invocation, or gateways. Aggregation can refer to the highest level of aggregation in a service provider network wherein the next level in the hierarchy under the core nodes is the distribution networks and then the edge networks. User equipment does not normally connect directly to the core networks of a large service provider but can be routed to the core by way of a switch or radio area network. Authentication can refer to determinations regarding whether the user requesting a service from the telecom network is authorized to do so within this network or not. Call control and switching can refer determinations related to the future course of a call stream across carrier equipment based on the call signal processing. Charging can be related to the collation and processing of charging data generated by various network nodes. Two common types of charging mechanisms found in present day networks can be prepaid charging and postpaid charging. Service invocation can occur based on some explicit action (e.g., call transfer) or implicitly (e.g., call waiting). It is to be noted that service “execution” may or may not be a core network functionality as third-party network/nodes may take part in actual service execution. A gateway can be present in the core network to access other networks. Gateway functionality can be dependent on the type of the interface with another network.

Furthermore, the terms “user,” “subscriber,” “customer,” “consumer,” “prosumer,” “agent,” and the like are employed interchangeably throughout the subject specification, unless context warrants particular distinction(s) among the terms. It should be appreciated that such terms can refer to human entities or automated components (e.g., supported through artificial intelligence, as through a capacity to make inferences based on complex mathematical formalisms), that can provide simulated vision, sound recognition and so forth.

Aspects, features, or advantages of the subject matter can be exploited in substantially any, or any, wired, broadcast, wireless telecommunication, radio technology or network, or combinations thereof. Non-limiting examples of such technologies or networks include Geocast technology; broadcast technologies (e.g., sub-Hz, ELF, VLF, LF, MF, HF, VHF, UHF, SHF, THz broadcasts, etc.); Ethernet; X.25; powerline-type networking (e.g., PowerLine AV Ethernet, etc.); femto-cell technology; Wi-Fi; Worldwide Interoperability for Microwave Access (WiMAX); Enhanced General Packet Radio Service (Enhanced GPRS); Third Generation Partnership Project (3GPP or 3G) Long Term Evolution (LTE); 3GPP Universal Mobile Telecommunications System (UMTS) or 3GPP UMTS; Third Generation Partnership Project 2(3GPP 2 ) Ultra Mobile Broadband (UMB); High Speed Packet Access (HSPA); High Speed Downlink Packet Access (HSDPA); High Speed Uplink Packet Access (HSUPA); GSM Enhanced Data Rates for GSM Evolution (EDGE) Radio Access Network (RAN) or GERAN; UMTS Terrestrial Radio Access Network (UTRAN); or LTE Advanced.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A method, comprising:
monitoring, by a device comprising at least one processor, a process operated by a system, wherein the monitoring is based on a logging parameter, wherein the monitoring is implemented using application code of the process;
based on the logging parameter and at least one result of the monitoring, generating, by the device, a log of the process; and
based on a condition determined to be associated with operation of the process:
during runtime of the process, changing, by the device, an operation of the process by modifying the application code, and
adjusting, by the device, the logging parameter.

2. The method of claim 1, wherein the logging parameter comprises a verbosity parameter representative of a verbosity of the log of the process.

3. The method of claim 1, wherein the logging parameter comprises a sampling rate parameter representative of a sampling rate applicable to the monitoring of the process.

4. The method of claim 1, wherein the logging parameter comprises a level of detail parameter representative of a level of logging detail of the log of the process.

5. The method of claim 1, wherein the log comprises a first log, and wherein the logging parameter comprises a parameter indicative of whether to add metadata to the first log to facilitate joining the first log to a second log of the process different from the first log.

6. The method of claim 1, further comprising, identifying, by the device, a pattern associated with the operation of the process, wherein the condition comprises a predicted change in the pattern associated with the operation of the process.

7. The method of claim 6, wherein the pattern comprises a historical pattern associated with the operation of the process, and wherein the predicted change comprises a predicted deviation in the operation of the process from the historical pattern.

8. The method of claim 7, wherein the identifying is based on a time series analysis of the operation of the process.

9. The method of claim 1, wherein the condition comprises a prediction that an error is threshold likely to occur, and wherein the changing of the operation of the process comprises reducing a likelihood of the occurrence of the error.

10. The method of claim 1, wherein the adjusting of the logging parameter is based on a model that was generated based on previous operations of the process.

11. The method of claim 10, wherein the model was generated further based on an analysis of feature importance by a random forest classifier.

12. The method of claim 10, further comprising, updating, by the device, the model, based on the condition, the adjusting of the logging parameter, and a result of the adjusting of the logging parameter.

13. The method of claim 1, wherein the condition comprises a predicted change in an operating state of the system.

14. The method of claim 1, wherein the condition comprises an anomaly in an operating state of the device.

15. A device, comprising:
at least one memory that stores computer executable components; and
at least one processor that executes the computer executable components stored in the at least one memory, wherein the computer executable components comprise:
a receiver that receives log data from monitoring equipment that monitors operation of a system based on a logging configuration, wherein the system comprises application code adapted to collect the log data,
a predictor that predicts a condition associated with the operation of the system, and
an adaptive logger that:
directly interfaces with the application code, and
during runtime, injects a logging behavior into the application code, wherein the logging behavior was selected based on the condition.

16. The device of claim 15, wherein the condition comprises an operational context of the system.

17. The device of claim 16, wherein the operational context comprises a demand load of the system satisfying a function with respect to a threshold amount of load.

18. A non-transitory machine-readable medium comprising executable instructions that, when executed by at least one processor, facilitate performance of operations, the operations comprising:
logging events of a process performed by a device, wherein the logging is based on a parameter, wherein the logging is implemented using application code of the process;
based on a model trained based on training data obtained from operation of the process, identifying a condition associated with operation of the process, resulting in an identified condition; and
based on the identified condition, during runtime of the process, changing, by the device, a logging operation of the process by modifying the application code.

19. The non-transitory machine-readable medium of claim 18, wherein the model comprises a time series model that was generated based on the training data obtained from the operation of the process.

20. The non-transitory machine-readable medium of claim 18, wherein the identified condition comprises satisfaction of a predicted level of efficiency of the logging of the events.
